(19) United States
(12) Patent Application Publication
(10) Pub. No.: US 2008/0149106 A1
(43) Pub. Date: Jun. 26, 2008

(54) Harness system for a breathing mask and method of using same

(76) Inventor: Bernard Joseph Beaudoin, Toronto (CA)

Correspondence Address: BERESKIN AND PARR, 40 KING STREET WEST, BOX 401, TORONTO, ON, M5H 3Y2, omitted

(21) Appl. No.: 11/642,542

(22) Filed: Dec. 21, 2006

(51) Int. Cl. A62B 18/00

(52) U.S. Cl. 128/207.11

(57) ABSTRACT

A harness system and method for securing an interface to a breathing orifice in a head of a person, having a back portion for mounting to a back surface of the head, a front portion for engaging the interface with the breathing orifice, a first deformable side portion for connecting a first side of the back portion to a first side of the front portion, and a second deformable side portion for connecting a second side of the back portion to a second side of the front portion, and a biasing structure for biasing the back portion against the back surface and the front portion towards a face surface of the head to secure the interface to the breathing orifice, and for biasing the first deformable side portion away from a first side of the head and the second deformable side portion away from a second side of the head, wherein, when the biasing structure secures the interface to the breathing orifice, the first deformable side portion is operable to allow the first side portion to contact the first side of the head and the second deformable side portion is operable to allow the second side portion to contact the second side of the head.

### FIELD

The present invention relates generally to breathing apparatuses and more specifically to securing a breathing apparatus to a person.

### BACKGROUND

Sleep apnea is a sleep disorder characterized by episodes of arrested breathing during sleep. A person afflicted with sleep apnea may experience a number of episodes during any particular sleep period, each lasting long enough so that one or more normal breathing cycles are missed. These interruptions of normal breathing are associated with a number of different health problems. If the arrest in breathing is complete and long enough in duration, it may lead to hypoxia or hypercapnia, and eventually trigger other serious medical consequences, such as brain damage and even death.

Sleep apnea occurs in two main varieties, Central Sleep Apnea (CSA) and Obstructive Sleep Apnea (OSA). CSA is caused by a neurological malfunction, where the brain essentially “forgets” to breathe, is fairly rare, and is usually quite mild. However, because its root cause is neurological, patients with CSA typically must be treated with medication.

OSA is a much more common form of sleep apnea. It is caused by a physical blockage of a person's airways when the tissue walls on the back of the throat collapse. OSA occurs during sleep when the body's muscles are in a highly relaxed state.

OSA can cause a number of serious health problems, including strokes, heart attacks and depression. Persons afflicted with OSA are also more likely to suffer other health problems, such as morning headaches, irritability, anxiety and loud snoring.

OSA can be effectively treated without medication by using a breathing apparatus. The breathing apparatus pumps a controlled stream of air at a positive pressure to a patient through an interface, typically a mask, that engages with the patient's mouth and/or nose. During use, the stream of positive airway pressure generated by the breathing apparatus forces the muscles in the patient's airway open, inhibiting the walls at the back of the throat from collapsing and reducing blockages. The overall effect is that incidents of OSA are greatly diminished or even eliminated.

Several different breathing apparatuses are currently available, including Continuous Positive Airway Pressure (CPAP), Variable Positive Airway Pressure (VPAP) and Automatic Positive Airway Pressure (APAP) machines. CPAP machines are the most basic, and deliver air at a constant pressure to the patient. VPAP machines are similar, but use an electronic circuit to monitor the patient's breathing and provide a slightly higher pressure when the patient is inhaling, and a slightly lower pressure when the patient is exhaling. APAP machines are the most advanced, and use pressure sensors to continuously monitor the patient's breathing and dynamically adjust the positive airway pressure to assist the patient when the patient is having difficulty breathing. Of course, breathing apparatuses such as the CPAP, VPAP and APAP machines may also be used to treat other conditions in addition to sleep apnea.

For the various breathing apparatuses to work properly, the interface or mask must be secured tightly to the patient's face to maintain a seal and prevent air leakage. This can be difficult as the patient often moves around or rolls from side to side during sleep, tending to dislodge the mask.

A nasal pillow may also be used to deliver pressured air to sleep apnea patients. Such nasal pillows are available, for example, from NasalAire™ by Innomed™. Nasal pillow do not use masks per se. Instead they use nasal inserts received by the patient's nostrils. However, nasal pillows often require a type of harness to be kept in place.

### SUMMARY

The embodiments described herein provide in one aspect, a harness system for securing an interface to a breathing orifice in a head of a person, having a back portion for mounting to a back surface of the head, a front portion for engaging the interface with the breathing orifice, a first deformable side portion for connecting a first side of the back portion to a first side of the front portion, and a second deformable side portion for connecting a second side of the back portion to a second side of the front portion, and a biasing structure for biasing the back portion against the back surface and the front portion towards a face surface of the head to secure the interface to the breathing orifice, and for biasing the first deformable side portion away from a first side of the head and the second deformable side portion away from a second side of the head. When the biasing structure secures the interface to the breathing orifice, the first deformable side portion is operable to allow the first side portion to contact the first side of the head and the second deformable side portion is operable to allow the second side portion to contact the second side of the head.

The embodiments described herein provide in another aspect, a method of securing an interface to a breathing orifice in a head of a person using a harness system, the method including mounting a back portion of the harness system on a back surface of the head, mounting a front portion of the harness system to the interface to engage the interface with the breathing orifice, connecting a first side of the back portion to a first side of the front portion using a first side portion of the harness system, flexibly positioning the first side portion of the harness system away from a first side of the head such that the first side portion is deformable to contact the first side of the head without dislodging the interface from the breathing orifice and is biased to return to a position away from the first side of the head, connecting a second side of the back portion to a second side of the front portion using a second side portion of the harness system, and flexibly positioning the second side portion of the harness system away from a second side of the head such that the second side portion is deformable to contact the second side of the head without dislodging the interface from the breathing orifice and is biased to return to a position away from the second side of the head.

### BRIEF DESCRIPTION OF THE DRAWINGS

The present invention will be better understood by reading the detailed description with reference to the accompanying drawing figures, in which like reference numerals denote similar structure and refer to like elements throughout, and in which:

FIG. 1 is an front elevation view of a harness mounted on a patient's head according to an embodiment of the present invention;

FIG. 2 is a side elevation view of the harness of FIG. 1;

FIG. 3 is a rear elevation view of the harness of FIG. 1;

FIG. 4 is a end view of the harness of FIG. 1 looking towards the patient's chin;

FIG. 5 is a perspective view of the harness of FIG. 1 shown in a deformed state where the patient is lying on his or her side;

FIG. 6 is a plan view of the harness of FIG. 1 shown in an unmounted, relaxed state; and

FIG. 7 is a side elevation view of a harness mounted on a patient's head in accordance with another embodiment.

### DETAILED DESCRIPTION

In describing embodiments of the present invention, as illustrated in the figures and/or described herein, specific terminology is employed for the sake of clarity. The invention, however, is not intended to be limited to the specific terminology so selected, and it is to be understood that each specific element includes all the technical equivalents that operate in a similar manner to accomplish similar functions.

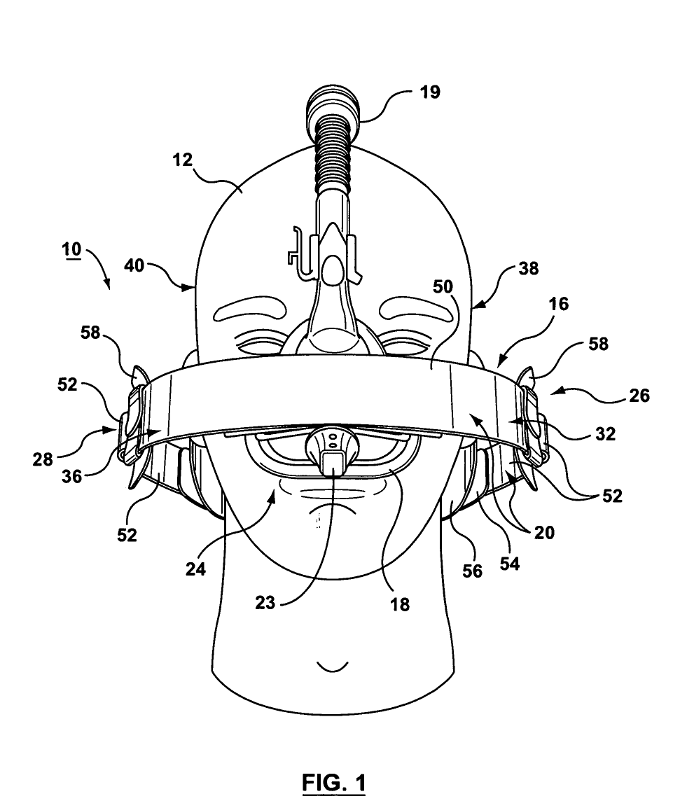

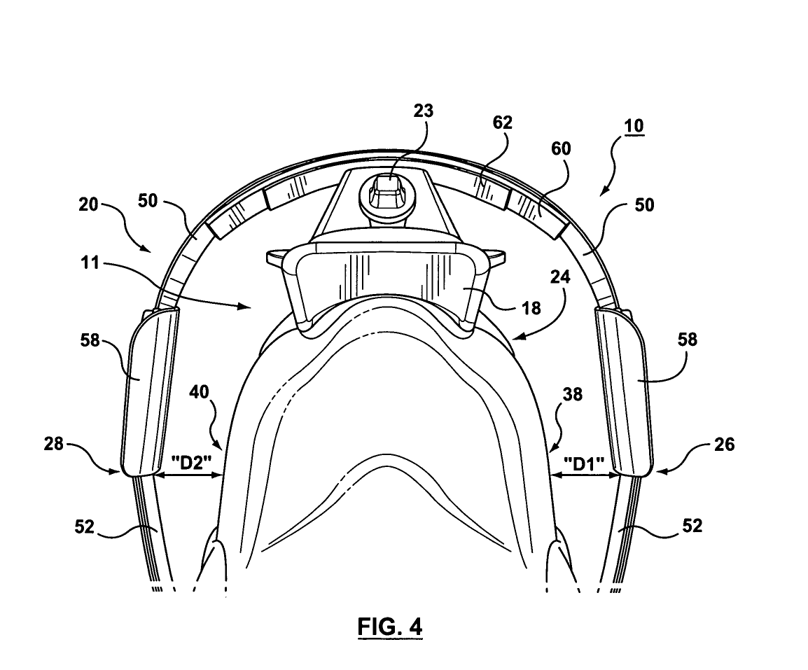

Referring generally to FIGS. 1 through 4, a harness 10 is shown mounted on a head 12 of a patient to be treated using a breathing apparatus, for example a patient suffering from OSA. As best shown in FIG. 4, the harness 10 comprises a generally annular structure having a central opening 11 for receiving the head 12. It will be appreciated by those skilled in the art that while the harness 10 is shown having a generally elliptical shape, the annular structure could have any other similar geometric shape, such as a rectangular, square or round shape, or any other shape sufficiently sized and configured with an opening 11 to receive the head 12.

The annular structure of the harness 10 comprises a back portion 14 and a front portion 16. The back portion is configured for mounting to a back surface of the head 22, and the front portion 16 is configured for engaging an interface, such as a mask 18, with a breathing orifice of the patient on a face surface 24 of the head 12. In some embodiments, the interface is designed to cover all of the user's nose and mouth. In other embodiments, the interface may cover only a portion of the mouth and/or nose as desired for a particular application. In other embodiments, such as, for example, nasal pillow embodiments, the interface may cover neither the nose nor the mouth. Instead, the nasal pillow may comprise inserts that can be pushed into the nostrils.

The annular structure of the harness 10 also comprises a biasing structure 20 for biasing the back portion 14 against the back surface 22 and the front portion 16 against the face surface 24 of head 12 to apply a transverse force between the back surface 22 and the face surface 24, generally securing the harness 10 to the head 12 and in particular securing the mask 18 to the face surface 24 over the orifice.

In the case of a mask 18 that contacts the person's face, the biasing structure 20 can secure the mask 18 to the face surface 24 with sufficient force to maintain an air tight seal between the mask 18 and the face surface 24, and to prevent the harness 10 from becoming dislodged from the head 12 when a patient moves during a sleep period. In the case of a nasal pillow, the biasing structure 20 can secure the nasal pillow inserts within the person's nostrils to prevent the inserts from being dislodged when the patient moves during sleep.

In some embodiments, to improve the seal between the mask 18 and the face surface 24, the mask 18 may have a pliable edge member, such as a foam or rubber edge, that deforms slightly under the transverse force provided by the biasing structure to conform to the features of the face surface 24.

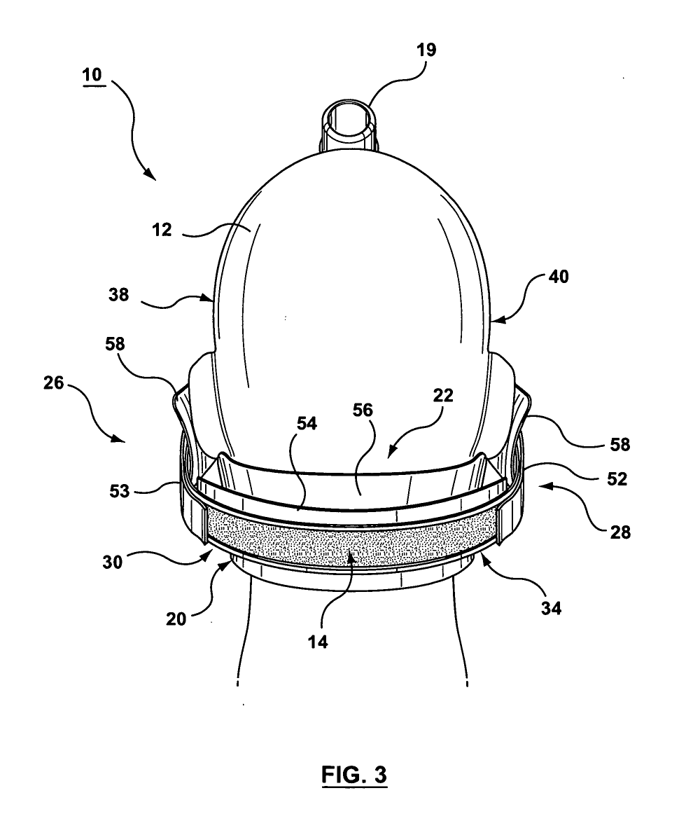

The biasing structure 20 also comprises a first side portion 26 proximate a first side surface 38 of the head 12, and a second side portion 28 proximate a second side surface 40 of the head 12 opposite the first side surface 38. The first side portion 26 connects a first rear side 30 (FIG. 3) of the back portion 14 to a first front side 32 (FIG. 1) of the front portion 16, while the second side portion 28 connects a second rear side 34 (FIG. 3) of the back portion 14 to a second front side 36 (FIG. 1) of the front portion 16, defining the annular structure with central opening 11. The distance between the first side surface 38 and the second side surface 40 of the head 12 is called the “head width”.

When mounted on the head 12, the biasing structure 20 is configured to bias the first side portion 26 away from the first side of the head 38 and to bias the second side portion 28 away from the second side of the head 40, as discussed in more detail below with reference to FIG. 4. This allows the harness 10 to be secured to the patient's head 12 for long periods of sleep without contacting the skin on the sides of the patient's head.

In order to be effective, the mask 18 and harness 10 are typically worn during an entire sleep period, usually between six and ten hours for most patients. If the harness 10 were in direct contact with the patient's facial skin for such a long period of time, it could result in marks on the patient's face that take time to fade after the harness 10 is removed, which is a common problem with existing harnesses. In many cases, particularly for patients with sensitive skin and elderly persons, the prolonged pressure of straps on their faces could irritate the skin and cause other longer-term skin problems, such as acne.

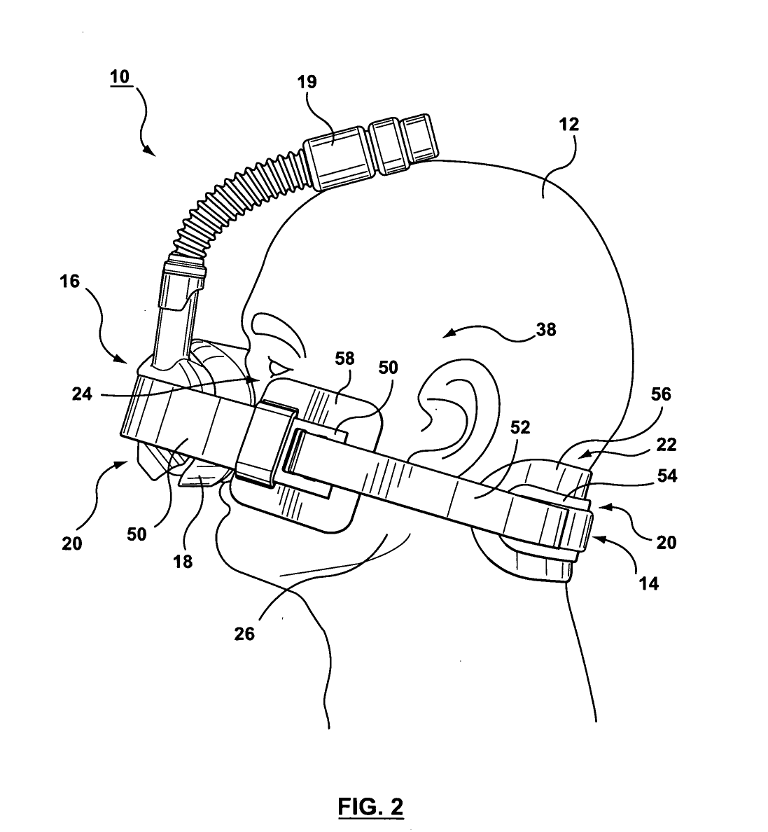

In this embodiment, front portion 16 of the biasing apparatus 20 comprises a resilient yet flexible elongate front spreader 50, connected to straps 52 that secure the front portion 16 to the back portion 14. The straps 52 are also connected to a resilient, flexible elongate rear spreader 54 (FIG. 2). The front spreader 50 and rear spreader 54 are biased to provide tension on the straps 52. When mounted, the front spreader 50 and rear spreader 54 can deflect from their rest positions and adopt a curved shape as shown in FIGS. 1 and 3. This deflection causes tension in straps 52 as the front spreader 50 and rear spreader 54 seek to return to their natural elongate state, generating the transverse force between the face surface 24 and the back surface 22.

In some embodiments, the width of the front spreader can be narrowed and the tensioners integrated into the tensioner. In such embodiments, a variety of semi-customized sizes and tensions could provide users with a selection of models from which they could choose the most appropriate model for them.

In some embodiments, straps 52 are releasably connected to the front spreader 50 and rear spreader 54, such as by the use of Velcro, securing loops or other suitable means that may or may not provide for adjustment. In other embodiments, straps 52 can be secured to front spreader 50 and rear spreader 54 in a manner that is not releasable.

The front spreader 50 and rear spreader 54 are sized and shaped in such a way as to dispose the harness 10 away from the first and second side surfaces 38, 40 when the harness 10 is mounted on the head 12. In particular, the front spreader 50 and rear spreader 54 are generally longer than the “head width”, and are sufficiently resilient such that during operation they dispose the straps 52 away from the first and second side surfaces 38, 40. In other embodiments, only one of the front spreader or the rear spreader is longer than the “head width” distance; however, both the front spreader 50 and rear spreader 54 extend laterally to a sufficient degree to dispose straps 52 away from side surfaces 38, 40. In other embodiments, the spreaders 50, 54 can be configured to adopt different shapes during use according to the needs of a particular application.

In some embodiments, the front spreader 50 and rear spreader 54 are made of a flexible, resilient plastic. In other embodiments, the front spreader 50 and rear spreader 54 are made from a flexible metal or other suitable material. In yet other embodiments, the front spreader 50 and rear spreader 54 may be rigid, and the straps 52 may be elastic. In such embodiments, when the harness 10 is mounted to head 12, the straps 52 adopt a stretched state, with the resulting tension providing the transverse force, while the spreaders 50, 54 dispose the straps 52 away from the side surfaces 38, 40. In yet another embodiment, flexible, resilient spreaders 50, 54 can be used in conjunction with elastic straps 52 to provide the necessary transverse force to secure the harness 10 to the head 12. In some embodiments, the length of the straps 52 is adjustable to adjust the size and shape of the harness 10 for use with different sizes and shapes of heads 12.

In some embodiments, the front spreader 50 and rear spreader 54 can adopt a curved shape when the harness 10 is mounted onto the head 12, that can help to secure the mask 18 to the front portion 16 and to more securely engage the back portion 14 of the harness 10 with the back surface 22.

The mask 18 can be secured to the front portion 16 in any number of ways, such as by being secured to spreader 50, using an elastic cord or any other suitably configured securing means, such as adhesives or locking tabs, or by engagement with a portion of a strap.

As shown in FIGS. 1 and 4, a rear cushion 56 can be situated between the rear spreader 54 and the back surface 22. The rear cushion 56 is designed to distribute the transverse force applied by the biasing structure 20 over a larger surface area on the back surface 22, minimizing pressure on the skin to reduce discomfort and irritation. In some embodiments the rear cushion 56 is made of plastic, and may be configured to match the contours of the back surface 22 of the head 12 of a particular user. In other embodiments, the rear cushion 56 is made of resilient foam, a rubber or other suitable material, and is sufficiently pliable to deform to match the profile of the back surface 22 of the head 12 when mounted.

In some embodiments, side cushions 58 are also connected to the straps 52, between the straps 52 and the side surfaces 38, 40 and proximate the front surface 16 for contacting the patient's face near the patient's cheekbones (FIG. 2). Like the rear cushion 56, the side cushions 58 are shaped and configured to inhibit the straps 52 from marking the patient's face when the patent is sleeping on his or her side by distributing pressure.

In some embodiments, the side cushions 58 may have a right hand and left hand configuration, depending on whether they are located on the first side portion 26 or the second side portion 28, in order to better conform to the shape of the patient's face. In some embodiments, the cushions are made of plastic, and are shaped to correspond to the features of the face. In some embodiments, the side cushions 58 are made of foam or a rubber, and are sufficiently pliable so as to conform to the contours of the patient's face when in contact with the patient's face. In some embodiments, the cushions can have a concave shape to shield the patient's face from the strap marks when the patient is sleeping on his or her side.

In some embodiments, the front spreader 50 is connected to a primary tensioner 60 and a secondary tensioner 62 positioned proximate the midpoint of the front spreader 50 between the front spreader 50 and the mask 18 (FIG. 4). The primary and secondary tensioners 60, 62 are generally made of a resilient flexible material, similar to the material used for the front spreader 50, and provide additional resiliency to the front spreader 50. The tensioners 60, 62 may also be adjustable to allow for configuration of the curvature of the front spreader 50 and to adjust the tension in the biasing structure 20 according to the needs of a particular user. The tensioner 60, 62 can optionally be secured by adhesive. Alternatively, the tensioners 60, 62 can be built into either the front spreader 50 or the rear spreader 54.

In some embodiments, the back portion 14 also comprises one or more rear tensioners 66 located proximate the midpoint of the rear spreader 54 to provide additional resiliency, and provide for adjustment of the curvature of the rear spreader 54 and of the transverse force generated by the biasing structure.

As shown in detail in FIG. 4, the biasing structure 20 operates to dispose the first side portion 26 and the second side portion 28 of the annular harness 10 at distances “D1” and “D2” from the first side of the head 38 and second side of the head 40, respectively. As shown in FIG. 4, the harness 10 is mounted on the head 12 and is in a “rest state”, meaning that no lateral forces are being applied to the first side portion 26 or the second side portion 28. In the “rest state”, “D1” and “D2” can be substantially equal. The harness 10 is typically in a “rest state” when the harness 10 is mounted on the patient and the patient is standing, sitting upright, or is lying on his or her back, substantially facing a ceiling.

In one embodiment, the harness 10 is configured for use with an adult sized head having a “head width” of approximately 20 cm. In this embodiment, the harness 10 and biasing apparatus 20 are configured so that “D1” and “D2” are approximately 2.5 cm when the harness 10 is in the “rest state”. The resilient front spreader 50 and rear spreader 54 extend beyond the first and second side surfaces 26, 28 of the head a distance greater than 2.5 cm, and have been deflected to adopt the curved shape shown in FIG. 4, causing “D1” and “D2” to be approximately 2.5 cm.

In other embodiments, the harness 10 is configured for use with a child's head, where the “head width” is approximately 5 cm. In such an embodiment, the harness 10 and biasing apparatus 20 are configured so that “D1” and “D2” are approximately 1 cm in length when the harness 10 is in the “rest state”.

It will be appreciated by those skilled in the art that the particular dimensions and characteristics of the harness 10 and its constituent parts can be modified to accommodate heads 12 of various shapes and sizes according to the physical characteristics of a particular patient, whether an adult, or a young person.

When in use, the harness 10 receives the head 12 via opening 11 and is secured in place. The mask 18 is then secured in place over the patient's mouth, and is connected to an air tube 19 that is in communication with a breathing apparatus, such as a CPAP, VPAP or APAP machine (not shown). The breathing apparatus provides air at positive airway pressure to the patient through the mask 18, inhibiting OSA. The air tube 19 can be integral part of the mask 18 and may connect via a swivel and another tube, to a CPAP or other machine. An exhaust cap 23 may also be provided on the mask to allow waste gases generated by the patient, such as carbon dioxide, to be expelled.

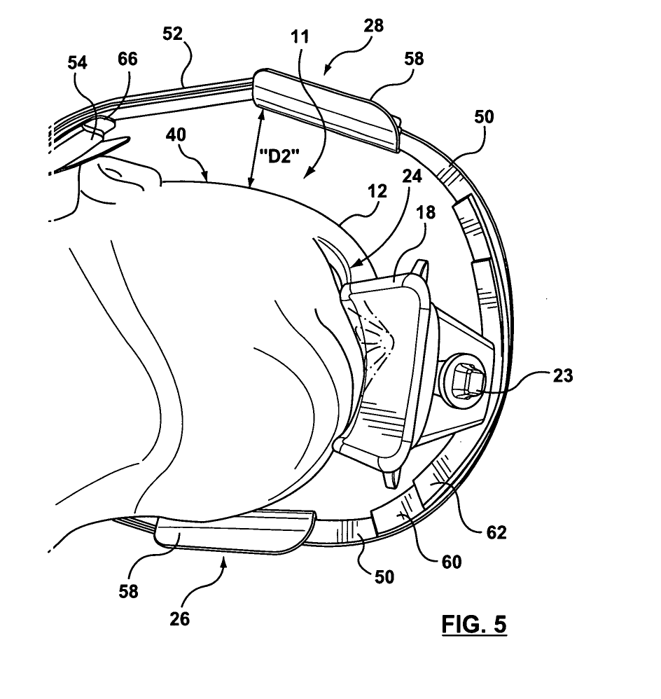

Most patients experience some form of movement during sleep, with many patients often rolling from side to side. It is unrealistic to expect a patient to remain lying on his or her back during an entire sleep period to keep the harness 10 in the “rest state” Therefore, the harness 10 accommodates this rolling action by adopting a “deformed state”, as shown in FIG. 5. When rolled on his or her side, the weight of the patient imparts a lateral force on the harness 10 acting for example against the first side portion 26 (FIG. 5). If the harness 10 were rigid and did not deform, the patient would be left trying to balance their head 12 on a relatively narrow side portion 26 with the head 12 being disposed at some distance from the ground surface. This result is undesirable, as it may lead to patient discomfort and ultimately result in the patient waking up. Alternatively, it may result in deflection of the mask 18 from the patient's mouth or nose. To resolve this problem, the harness 10, and in particular the straps 52 and front and rear spreaders 50, 54 are sufficiently pliable so that when the patient rolls to lie on his or her side, the harness 10 deforms to contact the sides of the patient's face.

In the example shown in FIG. 5, the patient is lying on his left side. In this position, the weight of the patient's head causes the first side portion 26 of the harness 10 to deform and engage the first side surface 38, reducing “D1” to substantially 0 cm. In some embodiments, the first side surface 38 engages with the side cushion 58 on the first side portion 26 to prevent direct contact between the patient's skin and straps 52, inhibiting the formation of marks on the patient's skin.

When in the “deformed state”, “D2” may be relatively unchanged from when the harness 10 is in the “rest state”, or alternatively “D2” may be larger or smaller, but “D2” is preferably greater than 0 cm so that side portion 28 continues to be disposed away from the second side surface 40. Furthermore, while not shown, it will be understood that when the patient is lying on his right side, the second side portion 28 is similarly deformable to contact the second side surface 40, reducing “D2” to substantially 0 cm.

When the patient is lying on his side and the harness 10 is in the “deformed state”, the biasing structure 20 remains operable to apply the transverse force between the face surface 24 and the back surface 22, biasing the back portion 14 of the harness 10 against the back surface 22 and the front portion 16 of the harness 10 against the face surface 24. In this manner, the harness 10 remains secured to the head 12 and the mask 18 remains secured over the patient's breathing orifice when the patient adopts different orientations during a sleep period.

When the patient shown in FIG. 5 moves from his left side to lie on his back, the harness 10 returns to the “rest state”, and the biasing structure 20 operates to return the first side portion 26 to the disposed position away from the first side surface 38. Pressure on the skin of the first side surface 38 can therefore be alleviated during a sleep period while the patient is still wearing the harness 10. This may reduce, or entirely eliminate, marking of the skin due to contact with the straps. Although the patient in FIG. 5 was lying on his left side and some marking of the skin may have occurred, movements of the patient from his left side to lie on his back or alternatively on his right side during a sleep period will alternately apply and remove pressure from the skin. Thus, the skin will be exposed to pressure from the harness 10 for a reduced duration of time, inhibiting irritation of the skin and other related skin problems.

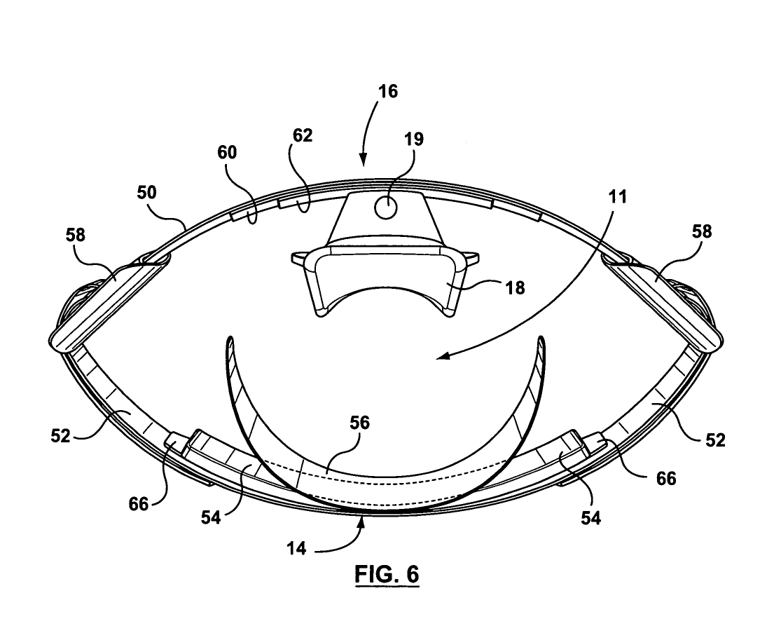

Turning now to FIG. 6, the harness 10 is shown in a “relaxed state”, when it is not mounted on the head 12. In the “relaxed state”, the annulus of the harness 10 adopts an elliptical shape caused by the action of the biasing structure 20 wherein the front spreader 50 and rear spreader 54 seek to return to their natural elongate states. In the relaxed state, the distance between the front portion 16 and the back portion 14 can be less than the distance between the face surface 24 and the back surface 22 of the head 12 for which this harness 10 is configured. Thus, the harness 10 can be deflected from its “relaxed state” into the “rest state” as shown in FIG. 4 for mounting onto the head 12

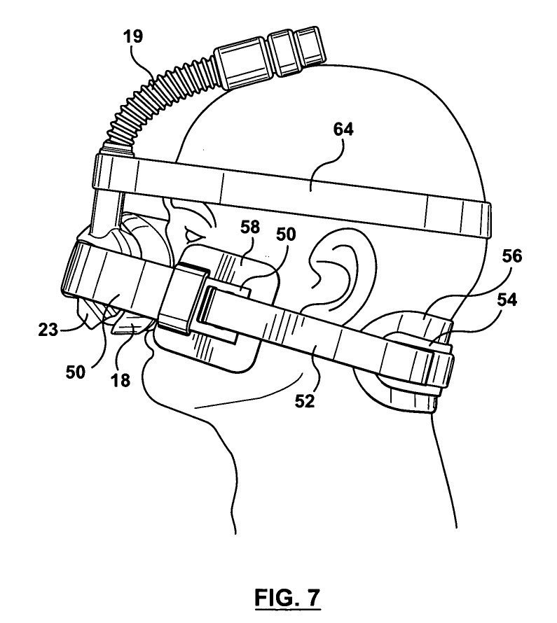

Turning now to FIG. 7, according to another embodiment shown, an upper strap 64 can be added to provide additional stability to the harness 10 when mounted to head 12. As shown, the upper strap 64 secures the air tube 19 to the head 12 by encircling the patient's head 12 proximate the crown, ears and eyes of the patient's head 12. Locating the upper strap 64 at this location tends to position it within the hairline of the patient, meaning that direct contact with the patient's skin tends to be avoided and skin irritation can therefore be minimized. In some embodiments, the upper strap 64 may also be equipped with concave cushions. In some embodiments, the upper strap 64 is made of an elastic material, and is stretched during use so as to provide a slight compressive force when mounted on the patient's head 12 to secure the air tube 19 to the user's head 12. In other embodiments, the upper strap 64 may incorporate one or more of a rear spreader, a front spreader, side cushions, front cushions and rear cushions, in order to improve user comfort.

In some embodiments, the side cushions 58 and rear cushion 56 may be covered by a covering, such as removable cotton covers which may be washable or disposable, and which make the cushions more breathable and help to further reduce the incidence of skin irritation when the patient is lying on his or her side during sleep.

In some embodiments, harness 10 may be used without the accompanying side or rear cushions 56, 58. In some embodiments, the harness 10 may rely on only the use of side and rear cushions 56, 58 to protect the patient's face from the straps 52 during sleep, and the rear and front spreaders 50, 54 would not be provided on the harness 10.

In some embodiments, strap 52 may be single wide strap

In another embodiment, a harness comprising a continuous hoop member made of a flexible, resilient material could be used.

Of course, the harness apparatus disclosed herein may be of use in securing a breathing apparatus or other similar device to a person for various other purposes, such as the treatment of other conditions in addition to sleep apnea.

Having thus described exemplary embodiments of the present invention, it should be noted by those skilled in the art that the within disclosures are exemplary only, and that various other alternatives, adaptations, and modifications may be made within the scope of the present invention. Accordingly, the present invention is not limited to the specific embodiments illustrated herein, but is limited only by the following claims.

1. A harness system for securing an interface to a breathing orifice in a head of a person, comprising:
a back portion for mounting to a back surface of the head,
a front portion for engaging the interface with the breathing orifice,
a first deformable side portion for connecting a first side of the back portion to a first side of the front portion, and
a second deformable side portion for connecting a second side of the back portion to a second side of the front portion; and
a biasing structure for biasing the back portion against the back surface and the front portion towards a face surface of the head to secure the interface to the breathing orifice, and for biasing the first deformable side portion away from a first side of the head and the second deformable side portion away from a second side of the head;
wherein, when the biasing structure secures the interface to the breathing orifice, the first deformable side portion is operable to allow the first side portion to contact the first side of the head and the second deformable side portion is operable to allow the second side portion to contact the second side of the head.

2. The harness system as defined in claim 1 wherein:
the biasing structure comprises a front member extending laterally beyond the first side of the head and second side of the head to bias the first deformable side portion away from the first side of the head and the second deformable side portion away from the second side of the head;
the first deformable side portion comprises a first flexible member secured to a first end of the front member; and
the second deformable side portion comprises a second flexible member secured to a second end of the front member.

3. The harness system as defined in claim 2 wherein
the biasing structure comprises a back member extending laterally past the first side of the head and second side of the head to bias the first deformable side portion away from the first side of the head and the second deformable side portion away from the second side of the head;
the first flexible member is secured to a first end of the back member; and
the second flexible member is secured to a second end of the back member.

4. The harness system as defined in claim 2 wherein the front member is made of a flexible, resilient material.

5. The harness system as defined in claim 2 wherein the front member extends laterally at least 1 cm beyond the first side and second side of the head.

6. The harness system as defined in claim 2 wherein the front portion has a length of at least 20 cm between its first side and second side, and the front member extends laterally at least 1 cm beyond the first side and second side of the front portion.

7. The harness system as defined in claim 3 wherein
the front member and the back member are both made of a flexible, resilient material;
the first flexible member has a first strap extending between the first end of the front member and the first end of the back member; and
the second flexible member has a second strap extending between the second end of the front member and the second end of the back member.

8. The harness system as defined in claim 7 wherein both the first strap and the second strap are elastic.

9. The harness system as defined in claim 1 wherein
the first deformable side portion comprises a first side cushion for contacting the first side of the head when the first deformable side portion is pushed against first side of the head; and
the second deformable side portion comprises a second side cushion for contacting the second side of the head when the second deformable side portion is pushed against the second side of the head.

10. The harness system as defined in claim 1 wherein the interface is mounted to the front portion.

11. The harness system as defined in claim 10 wherein the interface comprises a respiratory mask for providing a seal around the breathing orifice, the breathing orifice comprising one of a mouth, at least one nostril, and a combination of both the mouth and at least one of the nostrils.

12. The harness system as defined in claim 11 wherein the interface is in communication with a breathing apparatus having a source of respiratory gas and a conduit for providing a flow of respiratory gas to the breathing orifice.

13. A method of securing an interface to a breathing orifice in a head of a person using a harness system, the method comprising:
mounting a back portion of the harness system on a back surface of the head;
mounting a front portion of the harness system to the interface to engage the interface with the breathing orifice;
connecting a first side of the back portion to a first side of the front portion using a first side portion of the harness system;
flexibly positioning the first side portion of the harness system away from a first side of the head such that the first side portion is deformable to contact the first side of the head without dislodging the interface from the breathing orifice and is biased to return to a position away from the first side of the head;
connecting a second side of the back portion to a second side of the front portion using a second side portion of the harness system;
flexibly positioning the second side portion of the harness system away from a second side of the head such that the second side portion is deformable to contact the second side of the head without dislodging the interface from the breathing orifice and is biased to return to a position away from the second side of the head.

14. The method as defined in claim 13 further comprising adjusting the first side portion and the second side portion to seal the interface over the breathing orifice.

15. The method as defined in claim 14 further comprising connecting the interface to a breathing apparatus having a source of respiratory gas and providing a flow of respiratory gas to the breathing orifice.

16. The method as defined in claim 15 wherein the respiratory gas is provided at a supply pressure being greater than atmospheric pressure.
